(19) United States
(12) Patent Application Publication
(10) Pub. No.: US 2010/0002268 A1
(43) Pub. Date: Jan. 7, 2010

(54) Image communication apparatus

(75) Inventor: Takashi Sawano, Ibaraki-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/217,320

(22) Filed: Jul. 3, 2008

(30) Foreign Application Priority Data
Jul. 6, 2007 (JP) 2007-178854

(51) Int. Cl. H04N 1/32

(52) U.S. Cl. 358/442

(57) ABSTRACT

An information processing apparatus facsimile-transmits specified pages among images constituted by multiple pages, and transmits remaining pages by Internet FAX. The information processing apparatus transmits the specified pages to a FAX number specified by a user, by facsimile transmission. Next, the information processing apparatus transmits the remaining pages to a specified mail address by Internet FAX. Thus, the images are transmitted by the two kinds of FAX transmission to realize both of reduction in communication cost and prevention of leakage of confidential information.

### BACKGROUND OF THE INVENTION

1. Field of the Invention

The present invention relates to an image communication apparatus which performs facsimile transmission through a telephone line and transmission by Internet FAX through the Internet.

2. Description of the Related Art

Generally, an image processing apparatus having a FAX function transmits and receives images by facsimile communication through a telephone line. An information processing apparatus, such as a personal computer, which is connected to the Internet via a communication line, has an Internet FAX function of converting an image to a data format for facsimile communication and transmitting it to another information processing apparatus or an image processing apparatuses through the Internet.

The image processing apparatus is connected to the Internet through a network. Therefore, the image processing apparatus can transmit an image by Internet FAX. The information processing apparatus is connected to the image processing apparatus through the network. The information processing apparatus transmits an image to the image processing apparatus, and the image processing apparatus facsimile-transmits this image. That is, the information processing apparatus can indirectly perform facsimile transmission.

Thus, the image processing apparatus and the information processing apparatus are image communication apparatuses which perform common facsimile transmission through a telephone line and FAX transmission such as transmission by Internet FAX. In Japanese Patent Laid-Open No. 2002-344686, it is described that facsimile transmission or transmission by Internet FAX is selected according to communication counterparts to perform broadcast communication.

In the case of facsimile transmission, the cost is high. Especially when the data amount of a transmitted image is large, much communication time is required, and the cost remarkably increases. The communication cost of transmission by Internet FAX is low. However, since an image is transmitted as electronic data through a network, there is a problem that data leakage by interception and the like may occur, and it is difficult to protect the data. On the other hand, in facsimile transmission, data leakage does not occur, and it is possible to protect data.

In view of the above situation, the object of the present invention is to provide an image communication apparatus which enables both of reduction in communication cost and protection of data in FAX transmission of an image.

### SUMMARY OF THE INVENTION

The present invention is such that has a FAX driver which performs facsimile transmission and transmission by Internet FAX. When transmitting images by Internet FAX, the FAX driver facsimile-transmits a part of the images.

In the case of facsimile transmission, though communication cost is high, there is not a possibility of leakage of confidential information during communication. In transmission by Internet FAX, though communication cost is low, there is a data protection problem. Accordingly, when images are transmitted and a part of them have confidential information, the two kinds of FAX transmission are combined so that the part of the images are facsimile-transmitted. Thereby, both of reduction in communication cost and protection of data can be realized.

Here, the images are constituted by multiple pages, and the images to be facsimile-transmitted are specified pages. Pages having confidential information are specified and facsimile-transmitted. Pages which do not include confidential information are transmitted by Internet FAX.

Alternatively, the images to be transmitted by Internet FAX are all the pages. Though the pages which have been facsimile-transmitted are also included therein, the images can be managed as electronic data.

The FAX driver transmits information about the pages which have been facsimile-transmitted, by Internet FAX. The information about the facsimile-transmitted pages is attached to the data transmitted by Internet FAX. A user who receives the images can recognize the facsimile-transmitted pages.

When an image processing apparatus which has received the facsimile-transmitted images stores the images without printing them, the FAX driver transmits information required for printing the stored images by Internet FAX. When acquiring the information required for printing, the user who has received the facsimile-transmitted images can print the images. However, if he cannot acquire the information, he cannot print the images. Thus, this is useful to prevent leakage of confidential information.

When images are encrypted and stored in the image processing apparatus, the FAX driver transmits a decryption key by Internet FAX. That is, encrypted images are transmitted by facsimile transmission, or images received by the image processing apparatus are encrypted and stored. It is necessary to decrypt the images for printing them. Therefore, the decryption key is information required for printing. When the user who has received the images by Internet FAX can acquire the decryption key, he can print the stored image.

For each page, the FAX driver specifies facsimile transmission or transmission by Internet FAX. The specification for each page may be performed by the user. However, the FAX driver may automatically specify it so that the user operation can be simplified.

The FAX driver sets the same resolution for the images to be facsimile-transmitted and for the images to be transmitted by Internet FAX. When the FAX-transmitted images are printed, they look uniform.

The FAX driver performs facsimile transmission and transmission by Internet FAX to one image processing apparatus. That is, the image processing apparatus has a FAX number and a mail address. Therefore, one image processing apparatus can receive images by the two kinds of FAX transmission.

According to the present invention, by facsimile transmitting a part of images having confidential information and transmitting the rest by Internet FAX, leakage of the confidential information can be prevented to protect the data, and communication cost can be reduced. Thus, by combining the two kinds of FAX transmission according to the image to be transmitted, it is possible to construct a low-cost and high-security image communication system.

### BRIEF DESCRIPTION OF THE DRAWINGS

FIG. 1 is a diagram showing the entire configuration of an image communication system of the present invention;

FIG. 2 is a schematic block diagram of an information processing apparatus;

FIG. 3 is a diagram showing the configuration of software of the information processing apparatus;

FIG. 4 is a diagram showing the configuration of a PC-FAX driver;

FIG. 5 is a diagram showing a setting screen for specifying pages to be facsimile-transmitted;

FIG. 6 is a diagram showing a setting screen for specifying pages to be facsimile-transmitted;

FIG. 7 is a flowchart for sorting image pages;

FIG. 8 is a flowchart for FAX transmitting the sorted images;

FIG. 9 is a flowchart for sorting image pages according to another embodiment;

FIG. 10 is a flowchart for sorting image pages by adding information about facsimile transmission; and

FIG. 11 is a flowchart for sorting image pages according to another embodiment.

### DETAILED DESCRIPTION OF THE PREFERRED EMBODIMENT

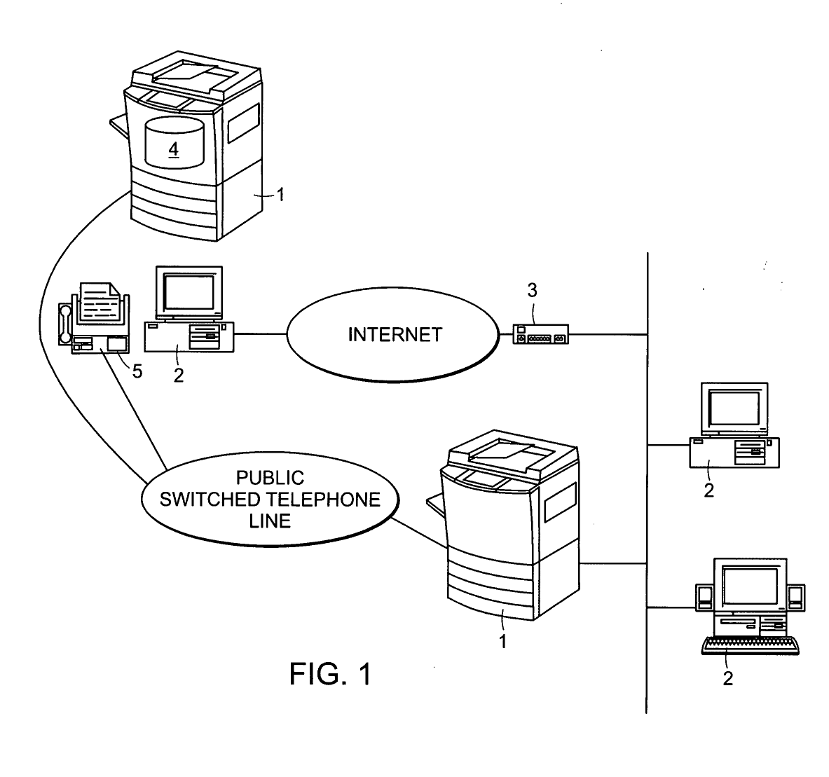

FIG. 1 shows an image communication system provided with an image communication apparatus of this embodiment. This image communication system is formed by connecting multiple image communication apparatuses through a network and a communication line. The image communication apparatuses have a function of transmitting and receiving images, and they are image processing apparatuses 1 and information processing apparatuses 2 such as a personal computer.

The image processing apparatuses 1 and the information processing apparatuses 2 are communicably connected via a LAN, a WAN or the like to form a network. The network is connected to the Internet via a router 3. The image processing apparatus 1 can communicate with other image processing apparatuses 1 and the information processing apparatuses 2 through the Internet.

The image processing apparatus 1 is an MFP which executes copying, printing, scanning, FAX communication and document filing, and it is provided with a hard disk apparatus 4. The image processing apparatus 1 is connected to a public switched telephone network (PSTN) to perform FAX communication with the other image processing apparatuses 1. The other image processing apparatuses 1 include a facsimile apparatus 5.

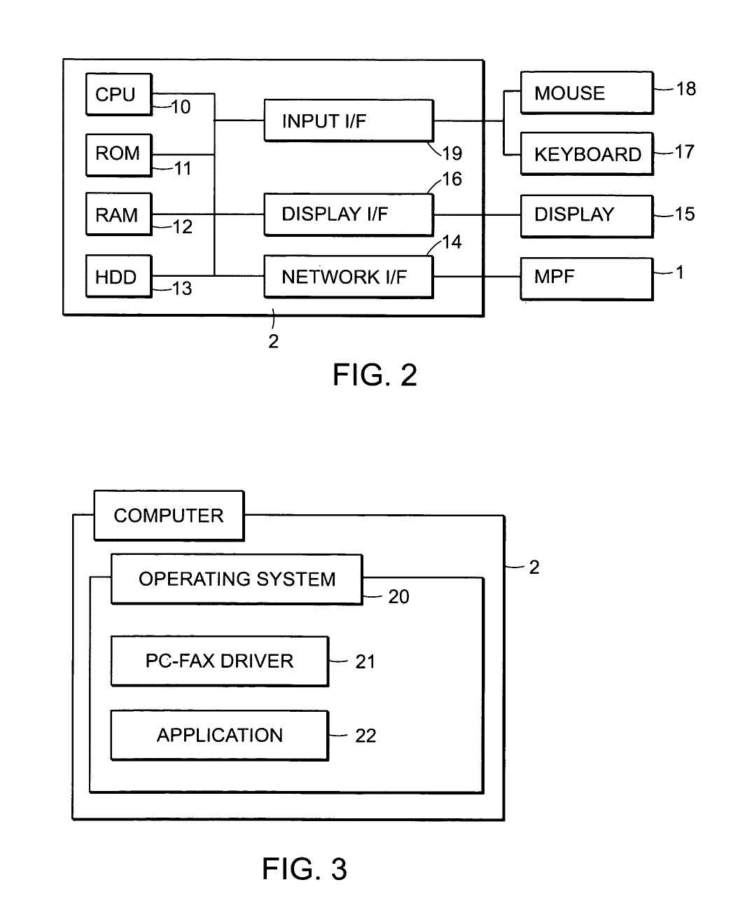

As shown in FIG. 2, the information processing apparatus 2 is provided with a CPU 10 which performs overall control of the information processing apparatus 2 itself, a ROM 11 which stores various programs, data and the like, a RAM 12 used as a work area where various data is temporarily stored, a hard disk apparatus (HDD) 13 which stores various programs, image data and the like, a network I/F 14 for communicating with an image processing apparatus via a network, a display I/F 16 which connects a display 15, and an input I/F 19 which connects pointing devices such as a keyboard 17 and a mouse 18.

In the information processing apparatus 2, the CPU 10 controls various devices in accordance with software. As shown in FIG. 3, an operating system 20 is mounted as basic software, and applications 22 including a PC-FAX driver 21 operate on this operating system 20. The driver causes peripheral equipment such as the mouse 18, the keyboard 17, the display 15 and the image processing apparatus 1 to be driven.

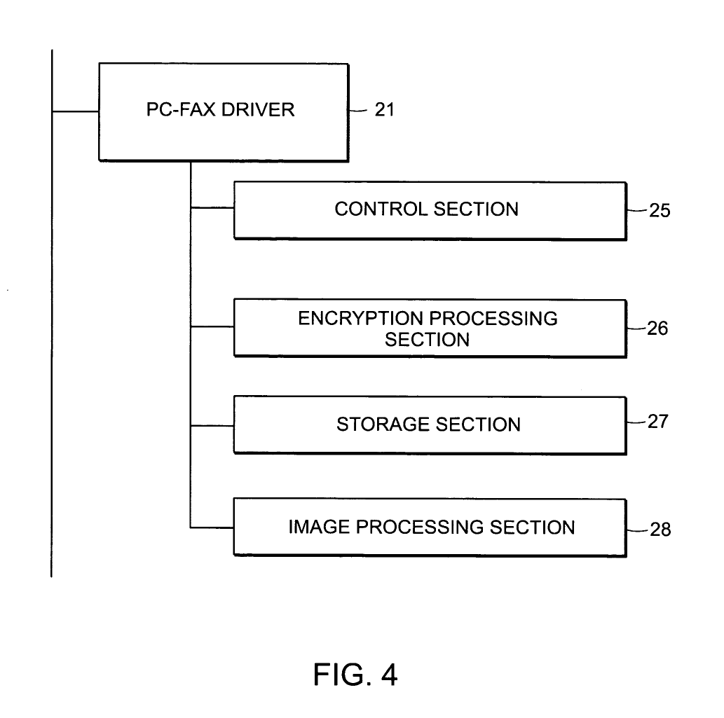

The information processing apparatus 2 has a FAX transmission function of transmitting images in two kinds of communication methods. The PC-FAX driver 21 executes facsimile transmission and transmission by Internet FAX. As shown in FIG. 4, the PC-FAX driver 21 is provided with a control section 25 which controls transmission of an image, an encryption processing section 26 which encrypts the data of an image, a storage section 27 which controls a memory for storing FAX information such as address information required for transmission and images, and an image processing section 28 which performs image processing.

By the application 22 such as word processor software creating images and activating the PC-FAX driver 21, the created images are transmitted. Alternatively, when a user specifies a file stored in the hard disk apparatus 4, the application 22 reads images and activates the PC-FAX driver 21, and thereby the read images are transmitted. Such images are constituted by multiple pages, and the PC-FAX driver 21 generates data for transmission in a predetermined format in accordance with output information such as the resolution, page size, page direction and the like which have been set.

In facsimile transmission, the PC-FAX driver 21 transmits images to an image processing apparatus 1 specified by the user. In this case, address information about the specified image processing apparatus 1 is transmitted to an image processing apparatus 1 within the same network. This address information is a FAX number. The image processing apparatus 1 transmits the images to the specified image processing apparatus 1 through the public switched telephone network.

In the case where the information processing apparatus 2 is provided with a modem, the modem is connected to the public switched telephone network. The PC-FAX driver 21 performs facsimile communication directly with another image processing apparatuses 1 via the modem.

In transmission by Internet FAX, the PC-FAX driver 21 attaches images to an electronic mail and transmits it to an information processing apparatus 2 or an image processing apparatus 1 specified by the user through the Internet. By inputting the mail address of the information processing apparatus 2 or the image processing apparatus 1 or selecting it from address information, the user-specifies the information processing apparatus 2 or the image processing apparatus 1.

Here, the PC-FAX driver 21 transmits the images by Internet FAX and facsimile-transmits a part of the images. That is, multiple pages are sorted for transmission by Internet FAX or for facsimile transmission, and transmitted to the same address by the two kinds of FAX transmission. In the case where the transmission-destination image processing apparatus 1 is connected to the public switched telephone network as well as to the Internet, the images are transmitted to the FAX number and the mail address of this image processing apparatus 1 by specifying the FAX number and the mail address. Furthermore, in the case where the user manages an image processing apparatus 1 or an facsimile apparatus 5 connected to the public switched telephone network and furthermore manages an image processing apparatus 1 or an information processing apparatus 2 connected to the Internet, by performing facsimile transmission to the image processing apparatus 1 or the facsimile apparatus 5 and performing transmission by Internet FAX to the information processing apparatus 2, the user can receive images by both of the two kinds of FAX transmission. In this case also, the transmissions are performed to the same address.

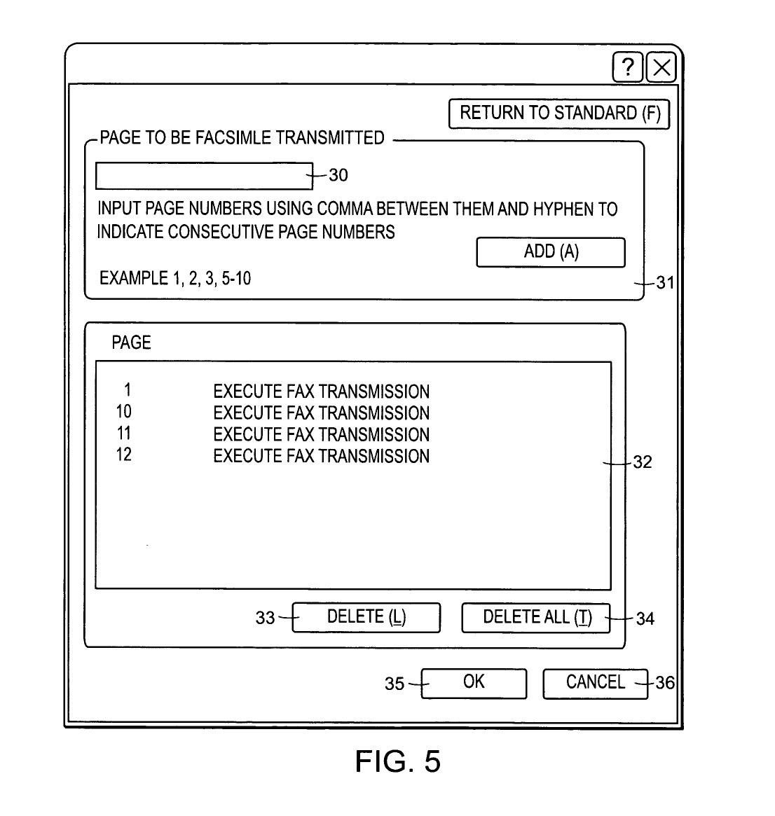

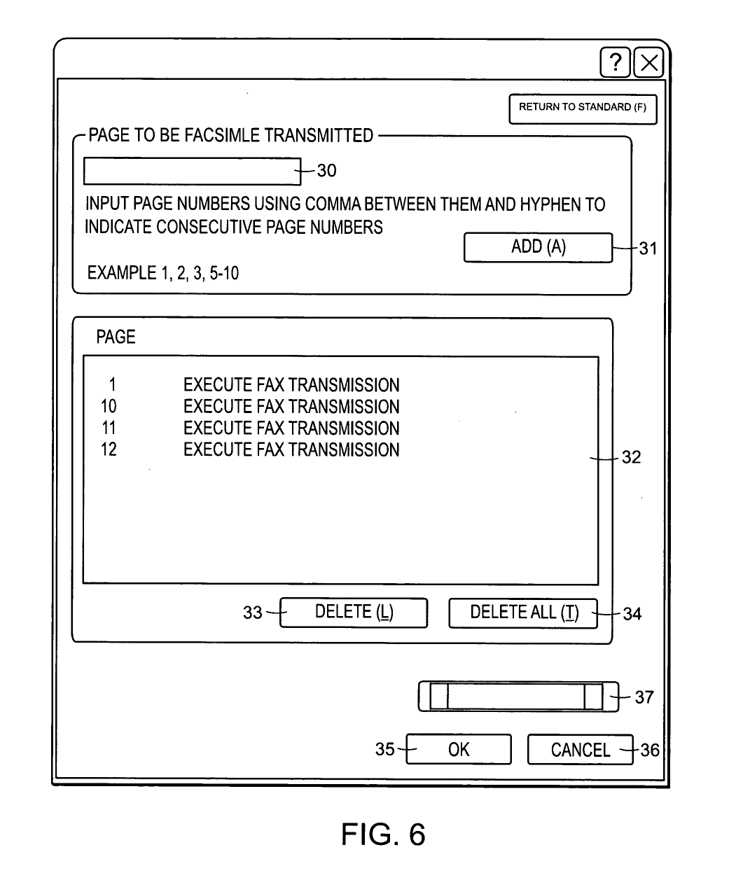

Sorting of pages is selected by the user. As shown in FIGS. 5 and 6, the PC-FAX driver 21 displays a setting screen. When the user specifies pages to be facsimile-transmitted, the PC-FAX driver 21 sets the pages to be transmitted as output information. Transmission by Internet FAX is set as a default. Pages which are not specified are transmitted by Internet FAX. In the figure, reference numeral 30 denotes an area where pages to be facsimile-transmitted are to be inputted. Reference numeral 31 denotes a button for validating input. Reference numeral 32 denotes an area where validated page numbers are displayed. Reference numeral 33 denotes a button for invalidating specified pages. Reference numeral 34 denotes a button for invalidating all the pages. Reference numeral 35 denotes a button for determining the inputted contents of settings. Reference numeral 36 denotes a button for canceling inputted contents of settings. Reference numeral 37 denotes a button for registering an application to execute the two kinds of FAX transmission.

The user sets pages having confidential information to be facsimile-transmitted, and pages not having confidential information to be transmitted by Internet FAX. By performing such sorting, it is possible to prevent leakage of the confidential information during transmission.

When sorting and transmitting images, the control section 25 makes setting for the output information so that the resolution of the images to be facsimile transmitted is the same as the resolution of the images to be transmitted by Internet FAX. Thereby, when the transmission-destination image processing apparatus 1 prints the received images, the images look uniform. Thus, it is possible to provide the user with the images without uncomfortable feeling.

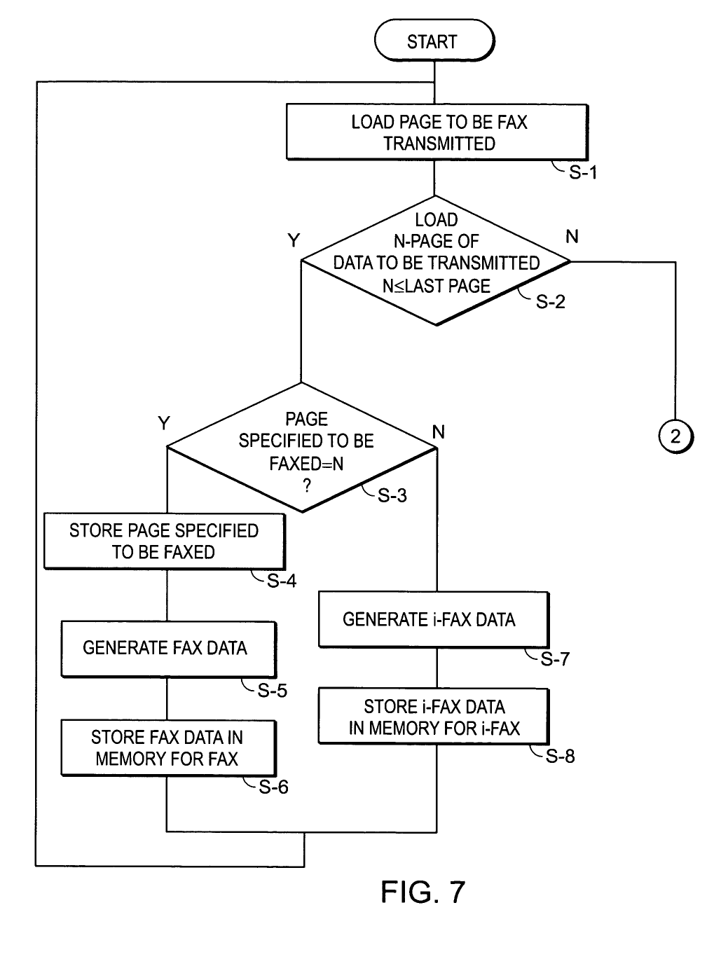

Next, an operation performed when the information processing apparatus 2 FAX transmits images. As shown in FIG. 7, the application 22 activates the PC-FAX driver 21 in response to a user instruction. The control section 25 of the PC-FAX driver 21 loads the data of a page of an image created by the applications 22 to a memory (S1). The control section 25 judges whether the loaded page is the final page or not (S2). When it is not the final page, the control section 25 judges whether or not facsimile transmission is specified for the page (S3).

In the case of performing facsimile transmission, the control section 25 stores the page number of this page in the memory (S4). The image processing section 28 generates FAX transmission data (S5) and stores the FAX data in the memory (S6). When the specified page is to be transmitted by Internet FAX, Internet FAX data (i-FAX data) is generated (S7), and the Internet FAX data is stored in the memory (S8). S3 to S8 are repeated up to the final page. In the memory, an area for storing FAX data and an area for storing Internet FAX data are formed.

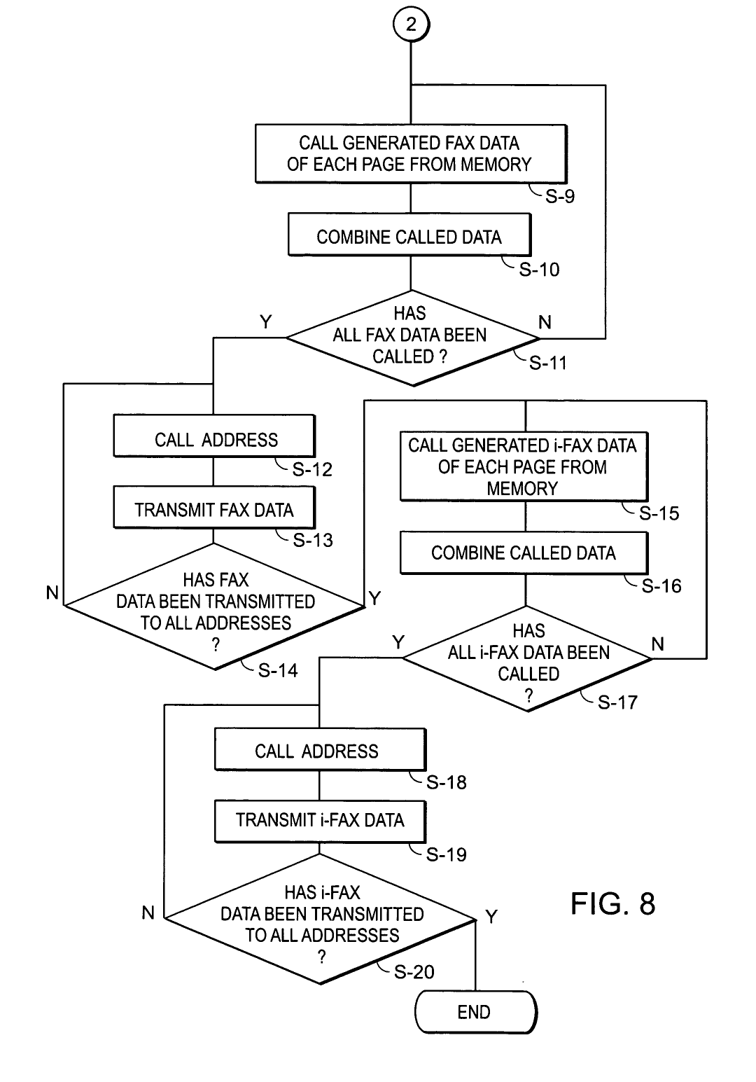

When all the pages are sorted, the control section 25 calls the FAX data of each page from the memory (S9) and combines the data for each page (S10) as shown in FIG. 8. When all the FAX data is called and combination is completed (S11), the control section 25 calls a specified address (FAX number) (S12) and facsimile-transmits the FAX data to the address (S13). When multiple addresses are specified, the FAX data is transmitted to each of the addresses (S14). This facsimile transmission is performed directly by the information processing apparatus 2 or performed via an image processing apparatus 1.

When facsimile transmission to all the addresses is completed, the control section 25 calls the Internet FAX data of each page from the memory (S15) and combines the data for each page (S16). When all the Internet FAX data is called and combination is completed (S17), the control section 25 calls a specified address (mail address) (S18) and transmits the Internet FAX data to the address by Internet FAX (S19). When multiple addresses are specified, the Internet FAX data is transmitted to each of the addresses (S20).

As described above, by facsimile transmitting a part of images, data protection can be realized; and, by transmitting the remaining images by Internet FAX, the communication time can be shortened, and the communication cost can be reduced.

As another form of FAX transmission, the PC-FAX driver 21 transmits all the images by Internet FAX as well as facsimile transmitting a part of the images. That is, all the pages are transmitted by Internet FAX, and specified pages are facsimile-transmitted.

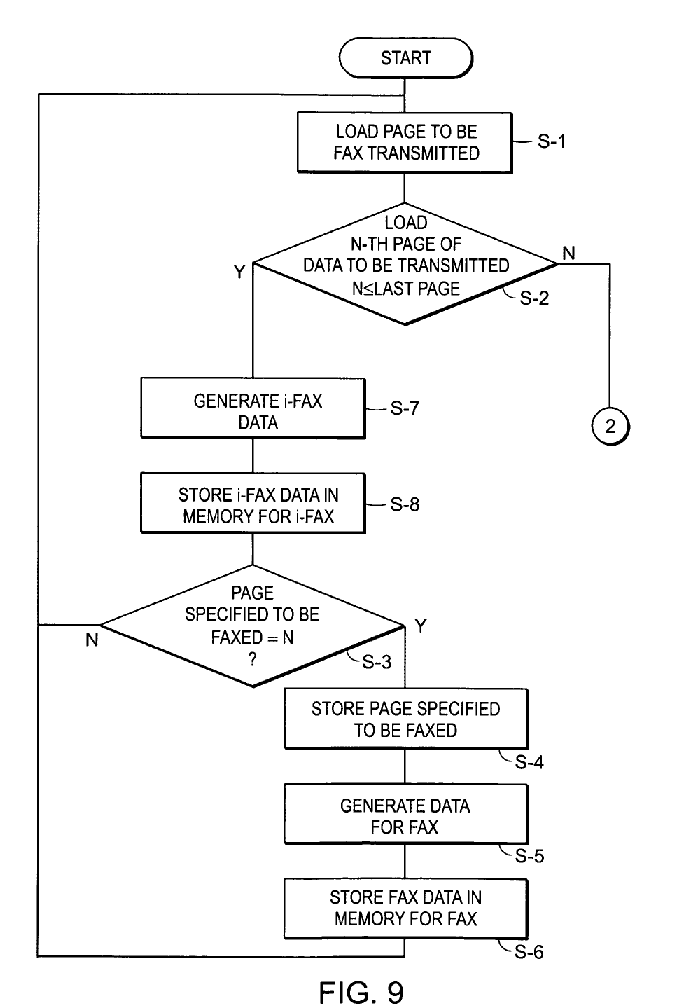

As shown in FIG. 9, the control section 25 of the PC-FAX driver 21 generates Internet FAX data of all the pages and stores the Internet FAX data in the memory. This operation is the same as the case described with reference to FIG. 7. In the case of a page specified to be facsimile-transmitted (S3), the control section 25 similarly stores the page number of this page in the memory (S4), and the image processing section 28 generates FAX transmission data (S5) and stores the FAX data in the memory (S6).

Then, the PC-FAX driver 21 transmits all the pages by Internet FAX and facsimile-transmits specified pages. By transmitting all the pages by Internet FAX, the transmitted images can be stored as electronic data, so that subsequent processing is facilitated.

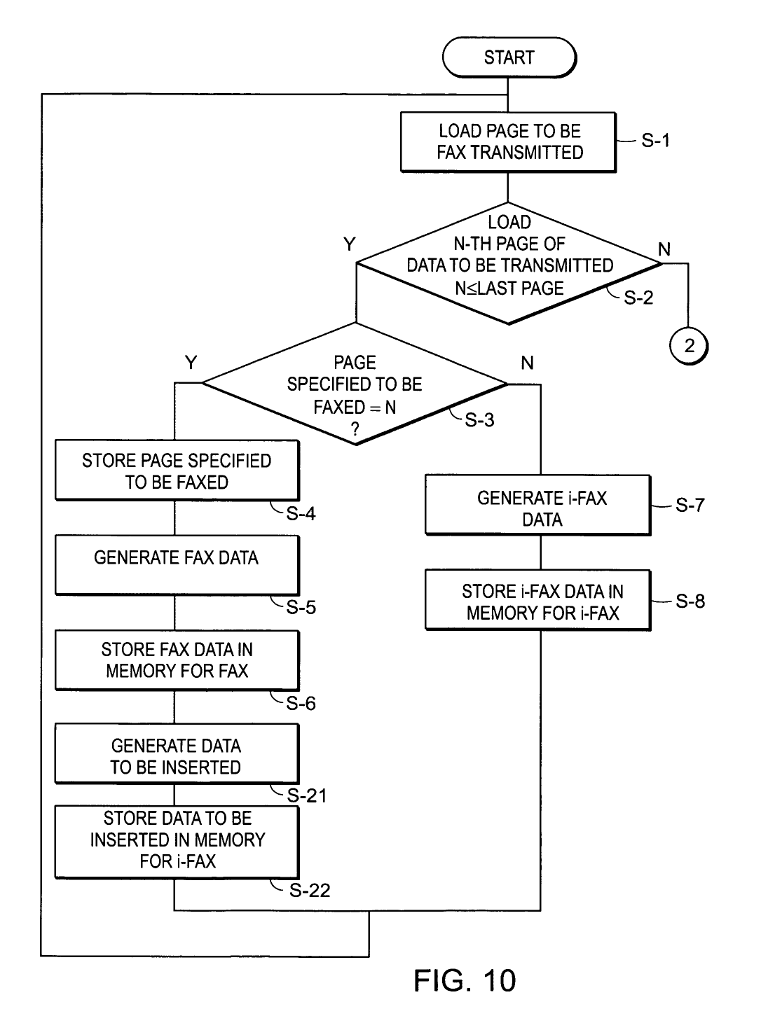

In the above description, specified pages are facsimile-transmitted in both cases. Therefore, the PC-FAX driver 21 provides information about the facsimile-transmitted pages to the transmission destination. That is, as shown in FIG. 10, after storing the FAX data of the specified pages in the memory, the control section 25 generates page information showing the facsimile-transmitted pages (S21), and stores the page information in the Internet FAX data storage area in the memory (S22). Other operations are the same as those in the case described with reference to FIG. 7.

Then, when images are transmitted by Internet FAX, the Internet FAX data including the page information is transmitted. Thereby, the facsimile-transmitted pages can be easily recognized among the images constituted by the multiple pages. The user can easily manage the images which he received.

The PC-FAX driver 21 also encrypts the images to be facsimile-transmitted. In the case of facsimile transmission, when the image processing apparatus 1 receives images, it prints and outputs the images. In this case, there occurs an opportunity for a third person to see images having confidential information, and this is undesirable from the viewpoint of security. Therefore, by transmitting encrypted images, the problem can be solved.

Before transmitting the FAX data at S13 shown in FIG. 8, the control section 25 encrypts the FAX data by an encryption key generated in advance. Then, the control section 25 transmits information about a decryption key by Internet FAX. That is, when data to be inserted is generated at S21 in FIG. 10, the information about the decryption key is included therein. The images to be transmitted by Internet FAX are pages other than the pages which have been facsimile-transmitted.

The image processing apparatus 1 which has received the facsimile-transmitted images stores the received images in the hard disk apparatus 4. These images are encrypted, so that they cannot be visually confirmed even if they are outputted as they are. The image processing apparatus 1 or the information processing apparatus 2 which has received the images by Internet FAX has a decryption key. The user decrypts the encrypted images with the use of this decryption key. Then, the received images are printed. If the image processing apparatus 1 which has received the images by facsimile transmission and the image processing apparatus 1 or the information processing apparatus 2 which has received the images by Internet FAX are different, the user performs an operation so that the decryption key is transferred from the latter to the former. The image processing apparatus 1 which has received the decryption key can decrypt the encrypted images. Therefore, only a user who receives the images by the two kinds of FAX transmission can confirm the images, and this is suitable for protection of confidential information.

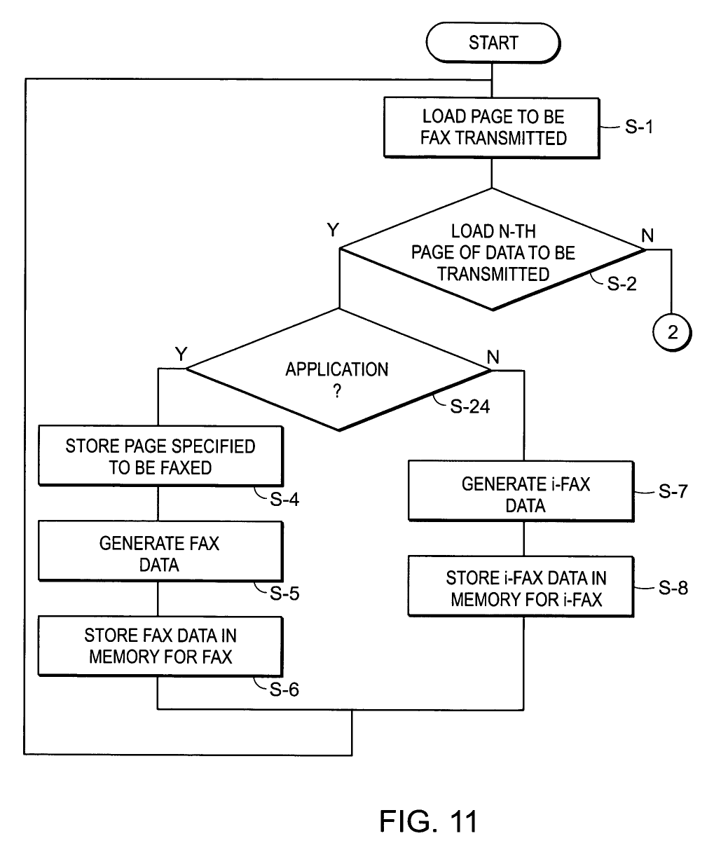

When images are sorted, the PC-FAX driver 21 may automatically perform sorting instead of the user specifying it. That is, as shown in FIG. 11, the control section 25 judges whether a page is a page of a file for which facsimile transmission is specified or a page by a registered application 22 (S24). In the case of a page of a file for which facsimile transmission is specified, FAX data is generated and stored. In the case of a page by the application 22, Internet FAX data is generated and stored.

Furthermore, the control section 25 detects pages which include confidential information, from among images constituted by multiple pages, and facsimile-transmits the pages which include confidential information. Pages which do not include confidential information are transmitted by Internet FAX. In the detection on whether confidential information is included or not, specific information indicating that the data of a page is confidential is attached to the data. The control section 25 makes a judgment on the basis of whether the specific information exists or not. Alternatively, it may be judged whether confidential information is included or not by detecting whether a specific image saying “confidential”, “for internal use only” or the like is included in an image within a page.

As described above, by automatically sorting pages, the necessity of a user operation is eliminated, and the burden on the user can be reduced.

The present invention is not limited to the embodiment described above. It goes without saying that a lot of modifications and changes can be made in the above embodiment within the scope of the present invention. It is also possible to divide an image of one page, facsimile-transmits a part of the one page, and transmits the rest by Internet FAX, instead of specifying the kind of FAX transmission for each page. An area having confidential information within the one page is cut off and set as FAX data. The remaining area is set as Internet FAX data. Thereby, even when an image of one page is FAX-transmitted, leakage of confidential information can be prevented. Then, one image processing apparatus receives images by the two kinds of FAX transmission. The image processing apparatus synthesizes the two images to generate one image.

The image processing apparatus which has received the facsimile-transmitted image does not print the image but stores it in the hard disk apparatus. The FAX driver transmits information required for printing the stored image by Internet FAX. Authentication information such as a password is separately transmitted as the information required for printing. By inputting the authentication information, the stored image can be printed. Thus, it is possible to prevent a third person from printing the image and taking it out.

Though an information processing apparatus performs sorting of images in the embodiment described above, an image processing apparatus may perform sorting of images.

What is claimed is:

1. An image communication apparatus comprising a FAX driver which performs facsimile transmission and transmission by Internet FAX, wherein, when transmitting images by Internet FAX, the FAX driver facsimile-transmits a part of the images.

2. The image communication apparatus according to claim 1, wherein the images are constituted by multiple pages, and images to be facsimile-transmitted are specified pages.

3. The image communication apparatus according to claim 2, wherein images to be transmitted by Internet FAX are all the pages.

4. The image communication apparatus according to claim 2, wherein the FAX driver transmits information about facsimile-transmitted pages via Internet FAX.

5. The image communication apparatus according to claim 2, wherein the FAX driver specifies facsimile transmission or transmission by Internet FAX for each page.

6. The image communication apparatus according to claim 1, wherein, when an image processing apparatus which has received the facsimile-transmitted images stores the images without printing the images, the FAX driver transmits information required for printing the stored images, by Internet FAX.

7. The image communication apparatus according to claim 6, wherein, when an image is encrypted and stored in the image processing apparatus, the FAX driver transmits a decryption key by Internet FAX.

8. The image communication apparatus according to claim 6, wherein the FAX driver sets the same resolution for images to be facsimile-transmitted and for images to be transmitted by Internet FAX.

9. The image communication apparatus according to any of claims 1 to 8, wherein the FAX driver performs facsimile transmission and transmission by Internet FAX to one image processing apparatus.
